(19) United States
(12) Patent Application Publication
(10) Pub. No.: US 2004/0181416 A1
(43) Pub. Date: Sep. 16, 2004

(54) Apparatus and method for granting/denying user requests for features of an application program

(76) Inventors: Yau-Jang Lee, Sunnyvale, CA (US); Yan Qi, Fremont, CA (US)

Correspondence Address: VICTOR H. OKUMOTO, P.O. BOX 6120, FREMONT, CA, 94538, US

(21) Appl. No.: 10/388,265

(22) Filed: Mar. 13, 2003

(51) Int. Cl. G06F 17/60

(52) U.S. Cl. 705/1

(57) ABSTRACT

An apparatus and method for granting/denying user requests for features of an application program are described. The method comprises: receiving a request from a user for a feature of an application program; retrieving a rule corresponding to the feature; if the rule is based upon an operation on attribute values, then retrieving the attribute values and determining whether to grant the request by applying the attribute values to the rule; and if the rule is based upon a keyword, then determining whether to grant the request according to a predefined understanding of the keyword. The apparatus includes at least one computer configured to perform the method.

### FIELD OF THE INVENTION

The present invention generally relates to features management for computer application programs and in particular, to an apparatus and method for granting/denying user requests for features of an application program.

### BACKGROUND OF THE INVENTION

In certain computer applications, it is useful to restrict at least some users from having complete access to all features of an application program. For example, when the application program manages a collaboration session, it may be useful to restrict which users may host the collaboration session, or which users may manage or access session resources.

In these and other applications, implementation problems arise when different customers want different rules for granting/denying user requests for features of an application program. For example, one customer may want to allow users having one set of attribute values to have access to a certain feature, while another customer may want to allow users having a different set of attribute values to have such access. Still other customers may want to allow all users to have access to the feature, while some other customers may want to not allow any users to have access.

A computer program may be written to grant/deny user requests for features of an application program according to a set of rules programmed into the computer program. This approach, however, may result in a commercially impractical solution for the vendor of the application program, because the computer program would have to be modified and such modified version maintained for each customer requiring a different set of rules for users to access the application program's features.

On the other hand, a computer program may also be written to simply query a database in which such rules are incorporated into user tables. This approach, however, may result in excessive effort on the part of customers to enter and maintain such tables in the database. In particular, if the customer decided to change such rules, a large number of table entries may have to be changed to accomplish such rule change, thus causing the customer much time, effort and aggravation in debugging and correcting entry errors.

### OBJECTS AND SUMMARY OF THE INVENTION

Accordingly, one object of the present invention is to provide a apparatus and method for granting/denying user requests for features of an application program that is easy to implement and maintain.

Another object is to provide a apparatus and method for granting/denying user requests for features of an application program that allows easy modification of rules for such granting/denying.

Still another object is to provide a apparatus and method for granting/denying user requests for features of an application program that is reliable and does not generally require excessive debugging and error correction.

These and additional objects are accomplished by the various aspects of the present invention, wherein briefly stated, one aspect of the invention is a apparatus for granting/denying user requests for features of an application program. The apparatus includes: computer readable information of users including attribute values associated with individual of the users; computer readable information of a set of rules including a corresponding rule for each feature of an application program; and a computer program indicating the granting/denying of a request by a user for a feature of the application program. The computer program performs such function by applying attribute values associated with the user to a rule corresponding to the feature, provided the rule indicates use of such attribute values. The attribute values in this case are retrieved from the computer readable information of users, and the rule is retrieved from the computer readable information of the set of rules.

Another aspect of the invention is method for granting/denying user requests for features of an application program, comprising: receiving a request from a user for a feature of an application program; retrieving a rule corresponding to the feature; and if the rule is based upon an operation on attribute values associated with the user, then retrieving attribute values corresponding to the user and determining whether to grant the request by applying the attribute values to the rule. On the other hand, in the preferred embodiment of the invention, if the rule is based upon a keyword, then the method is extended to determine whether to grant the request according to a predefined understanding of the keyword. Also, in the preferred embodiment of the invention, if the request is to pass a token granting a privilege to a recipient, then the method is extended to retrieve attribute values associated with the recipient and determine whether to grant the request by applying the attribute values thus retrieved to the rule.

Another aspect is a method for granting/denying user requests for features of a collaboration session manager, comprising: receiving a request from a user for a feature of a collaboration session manager; retrieving a rule corresponding to the feature from a rules file; and if the rule includes attribute values, then retrieving the attribute values and determining whether to grant the request by applying the attribute values to the rule.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 illustrates, as an example, a diagram of a first embodiment of an apparatus including software for granting/denying user requests for features of an application program, utilizing aspects of the present invention.

FIG. 2 illustrates, as an example, a diagram of a second embodiment of an apparatus including software for granting/denying user requests for features of an application program, utilizing aspects of the present invention.

FIG. 3 illustrates, as an example, a flow diagram of a method for granting/denying user requests for features of an application program, utilizing aspects of the present invention.

### DETAILED DESCRIPTION OF THE PREFERRED EMBODIMENT

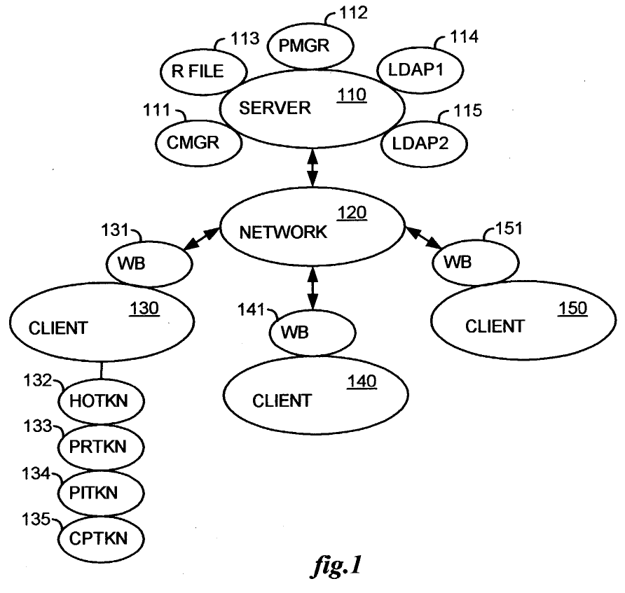

FIG. 1 illustrates, as an example, a diagram of an apparatus for granting/denying user requests for features of a collaboration session manager application program (“CMGR”) 111. The apparatus comprises a server computer 110 configured to include software such as a policy manager computer program (“PMGR”) 112, a rules file (“R FILE”) 113, and user directories 114 and 115 employing the Lightweight Directory Access Protocol (“LDAP”). The collaboration session manager 111, policy manager 112, rules file 113, and user directories 114 and 115 are stored on one or more memory units of the server computer 110, such as its system memory and/or a non-volatile memory unit such as a mass storage unit using either fixed or removable media.

The policy manager 112 may be a separate program from the collaboration session manager 111 or it may be integrated into it. User directory 114 includes user information for long-term users of the collaboration session manager 111, such as company employees and long-term contractors, and user directory 115 includes temporary user information for short-term users of the collaboration session manager 111, such as non-company users that are only participating in the current collaboration session or a number of collaboration sessions being held over a limited time period. The user directories 114 and 115 may be separate directories as shown, or one single directory. In addition, the user directories 114 and 115 may reside on the same server computer as shown, or the long term user directory 114 may be on a different server computer (referred to in this case as the “LDAP server”) which communicates with the server computer 110 through the network 120 or other connection means.

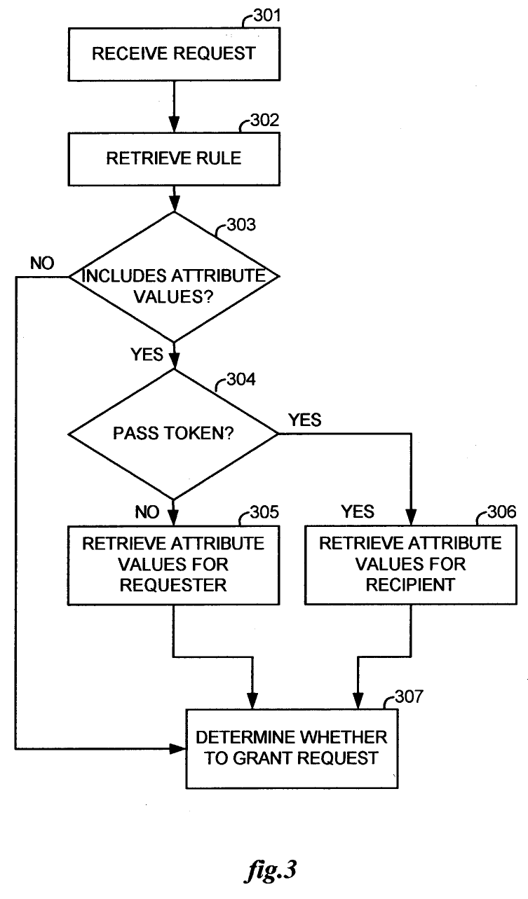

When granting a user request for a feature of the collaboration session manager 111, the policy manager 112 either enables or facilitates enabling the requested feature for the user. Conversely, when denying the request, it disables it or facilitates disabling it. The procedure used by the policy manager 112 in determining whether to grant or deny the user request is described in reference to FIG. 3.

Although for the purposes of the present invention, the application program referred to in the following claims may be any type of application program having numerous features that may be requested by a user, in the present example, it is the collaboration session manager 111 which is an application program for managing a collaboration session between users.

The collaboration session is initiated by a user operating, for example, client computer 130 communicating with the collaboration session manager 111 by, for example, supplying its Universal Resource Locator (“URL”) in its web browser 131. The communication session is scheduled by identifying a list of invited attendees to the collaboration session manager 111. Since all attendees must be identifiable by the collaboration session manager 111 so that it may allow or disallow their participation according to the invited attendee list, information identifying such attendees is preferably included in either the long-term user directory 114 or temporary user directory 115. If the invitee is not included in either directory, such identifying information is preferably added to one or the other user directory by the system administrator or other authorized party (e.g., a subadministrator) prior to the invitee participating in any collaboration sessions managed by the collaboration session manager 111.

As the initiator of the collaboration session, the user of client computer 130 initially holds certain tokens representing privileges that may be passed to a recipient who is another participant of the collaboration session, if such passing is allowable according to a set of rules defined in the rules file 113. A host token (“HOTKN”) 132 is held by the current host of the collaboration session. This token may be passed to another participant if the initiator leaves the collaboration session before its termination. A presenter token (“PRTKN”) 133 is held by the participant that is currently presenting information to the other participants. A pilot token (“PITKN”) 134 is held by the participant that is directly driving an application program whose output is being broadcast to other participants of the collaboration session, and the copilot token (“CPTKN”) 135 is held by another participant that is allowed by the pilot to remotely drive the application program whose output is being broadcast to the other participants. Any output being broadcasted is first sent to the server computer 110, which in turn, broadcasts the output to all active participants of the collaboration session.

Additional details of a collaboration session manager such as the collaboration session manager 111 are described in commonly owned U.S. patent application Ser. No. 09/563,658 entitled “Method and Apparatus for Conducting an Interactive Design Conference over the Internet,” filed May 2, 2000, which is incorporated herein by this reference; and commonly owned U.S. patent application Ser. No. 10,318,393 entitled “Method and Apparatus for Conducting a Collaboration Session in which Screen Displays are Commonly Shared with Participants,” filed Dec. 11, 2002, which is also incorporated herein by this reference.

Examples of features or privileges for the collaboration session manager 111 include:

sw_Host_Meeting_applic: the privilege to host a meeting on the application (i.e., initiate and lead the collaboration session).

sw_Copilot: the privilege to be a copilot.

sw_Create_Temp_User: the privilege to create a temporary user account.

sw_License_Usage: the privilege to see the license usage (i.e., the number of concurrent users currently active if the license is based upon a maximum number of concurrent users).

sw_License_Expiration_Warning: the privilege to show the license expiration warning (i.e., for a period-of-time or term license).

sw_Conference_Monitor: the privilege to enable the conference monitor function (i.e., see certain conference or collaboration session information such as the invitee list, current attendee list, conference or collaboration session meeting subject, scheduled meeting time, etc.). By default, only the system administrator can use the conference monitor to oversee ongoing meeting or session information. This privilege enables a specific user to use the function.

sw_Query_Solarlog: the privilege to query the solar log which includes session information such as starting time, ending time, participating users, etc. By default, a user can only see his or her own information. This privilege enables a specific user to see information on all other users in the log.

sw_Subadmin: the privilege to create or modify certain user information stored in the user directories 114 and 115. By default, only the system administrator can perform such functions.

sw_Upload: the privilege to upload a file or information to the server computer 110 in order to update a presentation database made available to the user holding the presenter token in the collaboration session.

sw_Manage_Solarlog: the privilege to manage the solar log (e.g., archive or delete old entries).

Sw_Manage_Database: the privilege to not only upload a file or information to the server computer 110, but also to perform directory management for the uploaded information (e.g., set up directory folders and subfolders).

In a collaboration session, users operating client computers, such as client computers 130, 140 and 150, communicate and otherwise collaborate with one another through a network 120 and server computer 110, under the control or management of the collaboration session manager 111. The network 120 may be the Internet, or an entity controlled network such as an Intranet or a Virtual Private Network (“VPN”). When collaborating over the Internet, the Secure Sockets Layer protocol (“SSL”) is preferably used for security purposes.

Although the client computers 130, 140 and 150, and the server computer 110 generally operate in a client/server relationship, this is not necessarily the case at all times. In particular, their roles may occasionally change during the collaboration session. Accordingly, the role of these computers during a collaboration session should not be limited by any client or server designation in the following description or claims.

Users collaborate through web browsers (such as web browsers 131, 141 and 151) running on their respective computers (such as client computers 130, 140 and 150). LDAP user directories 114 and 115 comprise computer readable information of the users including attribute values (i.e., values of attributes) associated with individual of the users. Examples of attributes include:

login: the user's identification for logging into the system.

password: the user's password for logging into the system.

email: the user's email address.

company: the user's company name.

apps: the name of the application program or programs that the user is allowed to use.

applic_dbdirs: the file upload directory name of the application program or programs.

privilege: list of features that this user may be allowed to have depending upon feature rules.

allowedip: client computer IP address that this user is allowed to log-on from.

create_time: for a temporary user whose account is valid for a period of time, the start time for that account.

expire_date: for a temporary user whose account is valid for a period of time, the end time for that account.

meeting_time: for a temporary user whose account is only valid for a collaboration session, the scheduled start time for that collaboration session.

The rules file 113 comprises computer readable information of a set of rules including a corresponding rule for each feature of the collaboration session manager 111. Preferably, the rules file 113 is generated from a configuration file that is read at system start-up and then stored in system memory. The format of the rules file is preferably in XML, as well as any configuration file from which it may be generated. The name for the configuration file is also preferably one such as “cxs.xml”.

The rules are preferably composed of attributes, attribute values, operators and/or keywords. There is generally only one rule per feature. Customers of the collaboration session manager 111 preferably define the rules, including which attributes in the LDAP user directories 114 and 115 are used in the rules, as well as the values of the attributes. The vendor of the collaboration session manager 111 generally provides the policy manager 112 which preferably defines or specifies the feature names, keywords, and operators usable in the rules.

The operators are preferably logical operators such as in the following table.

| Priority | Symbol | Function |
|---|---|---|
| 1 | ( ) | |
| 2 | ==, !=, [] | Logical EQUAL TO, NOT EQUAL |
| | | TO and CONTAIN (or INCLUDE) |
| 3 | && | Logical AND |
| 4 | \|\| | Logical OR |

As an example, a rule for a Feature1 of the collaboration session manager 111 may be defined as follows:

Feature1=“<attribute1>==<value1>||<attribute2 !=<value2>”

wherein attribute1=“valueOfattr1” and attribute2=“valueOfattr2”.

Note that the character “&” is a special symbol in an XML file, therefore to write the “&&” operator in a rule, the letters “amp” are added, for example, behind each “&” so that “&&”→“&amp&amp” to distinguish each “&” in the operator from the special character.

Examples of keywords include: @NONE, which means that the corresponding feature is turned off for all users; @ALL, which means that the corresponding feature is turned on for all users; and @VAR, which means that a variable is being specified. In the case of @ALL, this keyword can be eliminated by using the default rule that if a rule is not specified for a feature, then that feature will always be turned on (i.e., made available to all users).

As a simple example of a rule using a keyword, a rule for Feature2 of the application program 111 may be defined as follows:

Feature2=@NONE

so that no user will be able to access that feature.

In the case of @VAR, this keyword can be used to pass the variable from the wrapper function. As a simple example of a rule using a @VAR keyword, a rule for Feature1 may be defined as follows:

Feature1=“login==admin && apps[]@VAR”

so that the feature is granted to users who are system administrators (i.e., login==admin) as long as the application program (as specified in the user request) for the requested feature (as also specified in the user request) is one of the application programs listed in that user's “apps” attribute entry (see above for details on this attribute).

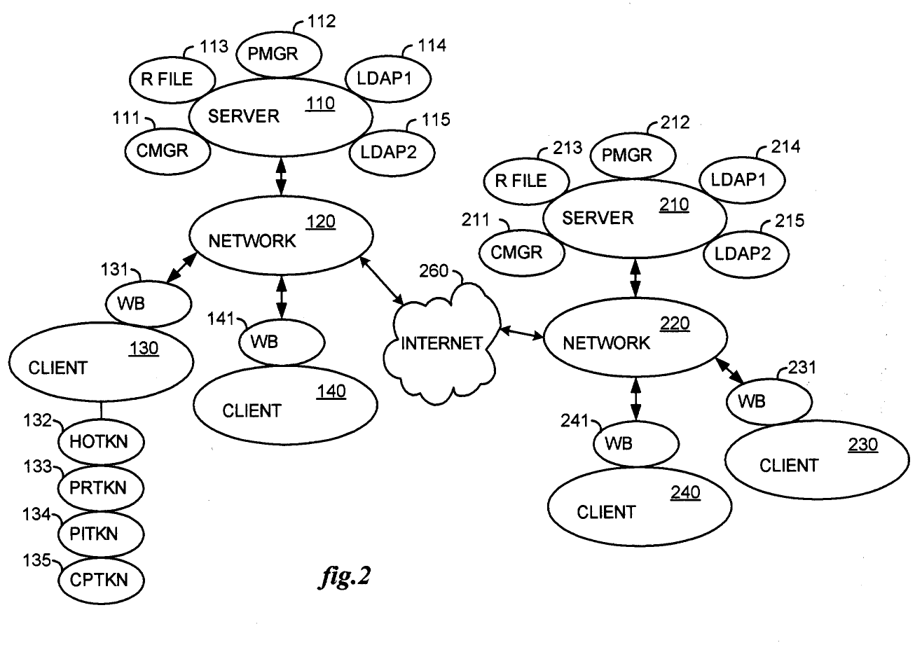

FIG. 2 illustrates, as an example, a diagram of an apparatus for granting/denying user requests for features of a collaboration session manager application program 111 during a collaboration session that includes participants from two different groups, wherein each of the groups wishes to apply its rules according to its rules file to its users whose information is included in its user directories. In this example, a first group includes server computer 110, network 120, and client computers 130 and 140 that are configured and operate as their identically reference numbered counterparts in the apparatus described in reference to FIG. 1. This first group has its own rules file 113 and user directories 114 and 115 that reside on one or more memory units of the server computer 110, and function as their identically reference numbered counterparts in the apparatus described in reference to FIG. 1. A second group includes server computer 210, network 220, and client computers 230 and 240 that are configured and operate as their counterparts in the first group. This second group has its own rules file 213 and user directories 214 and 215 that reside on one or more memory units of the server computer 210, and function as their counterparts in the first group.

In this example, the user operating client computer 130 has initiated the collaboration session and users operating client computers 140, 230 and 240 are invited attendees currently participating in the session. Therefore, the user operating client computer 130 initially holds the host token 132, the presenter token 133, the pilot token 134, and the copilot token 134. Also, since the initiating user is a member of the first group, the collaboration session manager 111 manages the collaboration session and the policy manager 112 facilitates granting/denying user requests for features of the collaboration session manager 111. Further, since users operating client computers 130 and 140 are in the first group, user information for each of them is already stored in the LDAP user directory 114. On the other hand, since users operating client computers 230 and 240 are not in the first group, user information for each of them must be stored in the LDAP user directory 115 by the system administrator or other authorized party prior to their participation in the collaboration session. In order for these users to subsequently participate, they log in with the collaboration session manager 111 through, for example, the Internet 260 after specifying the appropriate URL in their respective web browsers 231 and 241.

Since users operating client computers 130 and 140 are in the first group, policy manager 112 facilitates the granting/denying of their requests for features of the collaboration session manager 111 by applying their attribute values stored in the LDAP user directory 114 to rules corresponding to the requested features as retrieved from the rules file 113. On the other hand, since users operating client computers 230 and 240 are in the second group, policy manager 112 facilitates the granting/denying of their requests for features of the collaboration session manager 111 by preferably applying their attribute values stored in the LDAP user directory 214 to rules corresponding to the requested features as retrieved from the rules file 213. To accomplish this, the policy manager 112 preferably communicates with its counterpart, policy manager 212 residing on the server computer 210, to retrieve such information from its local rules file 213 and user directory 214 and send the retrieved information back, or perform the granting/denying determination and just send the result back to the policy manager 112 through, for the example, the Internet 260 operating through SSL for security purposes. Note that in this case, since the user information stored in the temporary LDAP directory 115 is primarily used for identifying temporary users to admit them into invited collaboration sessions, it does not require all the attribute value information as stored in the long-term LDAP directory 214 for such users.

FIG. 3 illustrates, as an example, a flow diagram of a method for granting/denying user requests for features of an application program such as 111 in FIG. 1 and FIG. 2. The method is preferably performed by a computer program such as 112 in FIG. 1 and FIG. 2.

In 301, a request for a feature of the application program is received from a user. In 302, a rule corresponding to the feature is retrieved from, for example, a rules file such as 113 in FIG. 1 or 213 in FIG. 2, depending upon which rules file is associated with the user making the request.

In 303, it is determined whether or not the rule includes attribute values. If the determination is NO, then the method proceeds directly to 307. On the other hand, if the determination is YES, then the method proceeds to 304 where it is next determined whether or not the request involves passing a token to another user.

If the determination in 303 is NO, then the method proceeds to 305 where attribute values corresponding to the requesting user are retrieved, for example, through a user directory such as 114 in FIG. 1 and 214 in FIG. 2, depending upon which user directory is the long term user directory associated with the requesting user. The method then proceeds to 307. On the other hand, if the determination in 304 is YES, then the method proceeds to 306 where attribute values corresponding to the proposed recipient of the token are retrieved, for example, through a user directory such as 114 in FIG. 1 and 214 in FIG. 2, depending upon which user directory is the long term user directory associated with the recipient user. The method then proceeds to 307.

In 307, if the determination in 303 was YES, then the method determines whether to grant the request by applying the attribute values retrieved in either 305 or 306 to the rule. On the other hand, if the determination in 303 was NO, then if the rule is based upon a keyword, the method determines whether to grant the request according to a predefined understanding of the keyword.

Although the various aspects of the present invention have been described with respect to a preferred embodiment, it will be understood that the invention is entitled to full protection within the full scope of the appended claims.

We claim:

1. An apparatus for granting/denying user requests for features of an application program, comprising:
computer readable information of users including attribute values associated with individual of said users;
computer readable information of a set of rules including a corresponding rule for each feature of an application program; and
a computer program indicating granting/denying a request by a user for a feature of said application program by applying attribute values associated with said user as retrieved from said computer readable information of said users to a rule corresponding to said feature as retrieved from said computer readable information of said set of rules, provided said rule indicates such granting/denying by applying said attribute values to said rule.

2. The apparatus according to claim 1, wherein said computer program grants said request by enabling said feature for said user, and denies said request by disabling said feature for said user.

3. The apparatus according to claim 1, wherein said application program is a collaboration session manager.

4. The apparatus according to claim 1, wherein said request is received from a computer operated by said user.

5. The apparatus according to claim 4, wherein said computer readable information of said users, said computer readable information of said set of rules, and said computer program are stored on one or more memory units of a first computer communicating through a network with said computer operated by said user.

6. The apparatus according to claim 5, wherein said application program is stored on said one or more memory units of said first computer.

7. The apparatus according to claim 5, wherein said network is an Intranet.

8. The apparatus according to claim 5, wherein said network is the Internet.

9. The apparatus according to claim 5, wherein said network is a Virtual Private Network.

10. The apparatus according to claim 5, wherein said attribute values associated with said user are retrieved through a directory incorporating the Lightweight Directory Access Protocol.

11. The apparatus according to claim 5, wherein said set of rules is stored in a rules file.

12. The apparatus according to claim 11, wherein said request is received from said user through a web browser running on said computer operated by said user.

13. The apparatus according to claim 12, wherein said rules file is an XML file.

14. The apparatus according to claim 5, wherein said set of rules include logic operators acting on attribute values.

15. The apparatus according to claim 14, wherein if said request indicates passing of a token granting a privilege to a recipient user, then said computer program indicates granting/denying said request by applying attribute values associated with said recipient to said rule, provided said rule indicates such granting/denying by applying said attribute values associated with said recipient to said rule.

16. The apparatus according to claim 14, wherein said set of rules include use of keywords indicating special operations.

17. The apparatus according to claim 16, wherein one of said keywords indicates that an associated feature is disabled for all users.

18. The apparatus according to claim 16, wherein one of said keywords indicates that an associated feature is enabled for all users.

19. The apparatus according to claim 16, wherein if said rule corresponding to said feature includes use of a keyword, then said computer program grants/denies said request by said user for said feature according to a predefined understanding of said keyword instead of applying attribute values associated with said user to said rule.

20. The apparatus according to claim 4, wherein said program is stored on a first memory unit of a first computer, and said computer readable information of said users and said computer readable information of said set of rules are stored on one or more memory units of a second computer communicating with said first computer through a communication medium and with said computer operated by said user through a network.

21. The apparatus according to claim 20, wherein said communication medium is the Internet.

22. The apparatus according to claim 21, wherein said first computer and said second computer communicate through said Internet using SSL.

23. The apparatus according to claim 20, wherein said application program resides on said first memory unit of said first computer.

24. The apparatus according to claim 20, wherein said network is an Intranet.

25. The apparatus according to claim 20, wherein said network is the Internet.

26. The apparatus according to claim 20, wherein said network is a Virtual Private Network.

27. The apparatus according to claim 20, wherein said attribute values associated with said user are retrieved through a directory incorporating the Lightweight Directory Access Protocol.

28. The apparatus according to claim 20, wherein said set of rules is stored in a rules file.

29. The apparatus according to claim 28, wherein said request is received from said user through a web browser running on said computer operated by said user.

30. The apparatus according to claim 29, wherein said rules file is an XML file.

31. The apparatus according to claim 20, wherein said set of rules include logic operators acting on attribute values.

32. The apparatus according to claim 31, wherein if said request indicates passing of a token granting a privilege to a recipient user, then said computer program indicates granting/denying said request by applying attribute values associated with said recipient to said rule, provided said rule indicates such granting/denying by applying said attribute values associated with said recipient to said rule.

33. The apparatus according to claim 31, wherein said set of rules include use of keywords indicating special operations.

34. The apparatus according to claim 33, wherein one of said keywords indicates that an associated feature is disabled for all users.

35. The apparatus according to claim 33, wherein one of said keywords indicates that an associated feature is enabled for all users.

36. The apparatus according to claim 33, wherein if said rule corresponding to said feature includes use of a keyword, then said computer program grants/denies said request by said user for said feature according to a predefined understanding of said keyword instead of applying attribute values associated with said user to said rule.

37. A method for granting/denying user requests for features of an application program, comprising:
receiving a request from a user for a feature of an application program;
retrieving a rule corresponding to said feature; and
if said rule is based upon an operation on attribute values, then retrieving said attribute values and determining whether to grant said request by applying said attribute values to said rule.

38. The method according to claim 37, wherein said retrieving said attribute values includes retrieving said attribute values from a user directory including information of attribute values associated with said user.

39. The method according to claim 37, wherein said request indicates passing a token granting a privilege to a recipient, and said retrieving said attribute values includes retrieving said attribute values from a user directory including information of attribute values associated with said recipient.

40. The method according to claim 37, further comprising: if said rule is based upon a keyword, then determining whether to grant said request according to a predefined understanding of said keyword.

41. The method according to claim 37, wherein said application program is a collaboration session manager.

42. The method according to claim 37, wherein said receiving a request from a user for a feature of an application program, comprises receiving said request from said user through a web browser running on a computer operated by said user.

43. The method according to claim 42, wherein said retrieving a rule corresponding to said feature, comprises retrieving said rule from information of a set of rules stored in a rules file.

44. The method according to claim 43, wherein said rules file is an XML file.

45. The method according to claim 42, wherein said retrieving attribute values, comprises retrieving said attribute values from information retrieved through a directory incorporating the Lightweight Directory Access Protocol.

46. The method according to claim 42, wherein said receiving said request, comprises receiving said request over a network from said computer operated by said user.

47. The method according to claim 46, wherein said network is an Intranet.

48. The method according to claim 46, wherein said network is the Internet.

49. The method according to claim 46, wherein said network is a Virtual Private Network.

50. A method for granting/denying user requests for features of a collaboration session manager, comprising:
receiving a request from a user for a feature of a collaboration session manager;
retrieving a rule corresponding to said feature from a rules file; and
if said rule includes attribute values, then retrieving said attribute values and determining whether to grant said request by applying said attribute values to said rule.

51. The method according to claim 50, further comprising: if said rule includes attribute values and said request is not for passing a token granting a privilege to a recipient user, then said retrieving said attribute values includes retrieving said attribute values from a user directory including information of attribute values associated with said user.

52. The method according to claim 50, further comprising: if said rule includes attribute values and said request is for passing a token granting a privilege to a recipient user, then said retrieving said attribute values includes retrieving said attribute values from a user directory including information of attribute values associated with said recipient.

53. The method according to claim 50, further comprising: if said rule is based upon a keyword, then determining whether to grant said request according to a predefined understanding of said keyword.

54. The method according to claim 50, wherein said rules file is generated upon system start-up from information stored in a configuration file.

55. The method according to claim 54, wherein said rules file is an XML file.
